(19) United States
(12) Patent Application Publication
(10) Pub. No.: US 2024/0261173 A1
(43) Pub. Date: Aug. 8, 2024

(54) HIGH FREQUENCY CHEST WALL OSCILLATION THERAPY APPARATUS HAVING VARYING BASELINE PRESSURE

(71) Applicant: Hill-Rom Services PTE.LTD., Singapore (SG)

(72) Inventors: Aaron Alexander Ayu, Singapore (SG); Gee Han Png, Singapore (SG); Justin Xuan Kai Liew, Singapore (SG); Yaolong Lou, Singapore (SG); Karen Mullery, St. Paul, MN (US); Stacey Reuland, Chanhassen, MN (US); Chee Leong Tan, Singapore (SG); GuoXiang Wang, Singapore (SG)

(21) Appl. No.: 18/413,410

(22) Filed: Jan. 16, 2024

Related U.S. Application Data
(60) Provisional application No. 63/483,792, filed on Feb. 8, 2023.

(51) Int. Cl. A61H 9/00

(52) U.S. Cl. CPC A61H 9/0078; A61H 2230/405

(57) ABSTRACT

A method of improving comfort with a high-frequency chest wall oscillation (HFCWO) system includes calculating a plurality of airflow metrics of a first therapy and a second therapy. An efficacy score of each of the plurality of airflow metrics is calculated based on a comparison of each airflow metric of the second therapy to each respective airflow metric of the first therapy. A total score of the second therapy is determined based on a combination of the efficacy scores of each of the plurality of airflow metrics and a comfort level of the second therapy.

### CROSS-REFERENCE TO RELATED APPLICATIONS

This application claims priority under 35 U.S.C. § 119(e) to U.S. Provisional Application No. 63/483,792, filed Feb. 8, 2023, which is expressly incorporated by reference herein.

### BACKGROUND

The present disclosure relates to a high frequency chest wall oscillation (HFCWO) air pulse generator and, in particular, to a HFCWO air pulse generator having an adjustable baseline pressure.

High-frequency chest wall oscillation (HFCWO) is performed using an inflatable garment that is attached to an air pulse generator through air hoses. The HFCWO system mechanically performs chest physical therapy by vibrating at a high frequency. This is done by rapid mechanical compression of air in an fluid chamber within the air pulse generator. The compressed air is transferred to the garment through the air hoses. The garment vibrates the chest to loosen and thin mucus. At a predetermined time, the patient stops the air pulse generator and coughs or huffs.

Respiration during therapy results in ribcage movements exerting pressure on the garment. For example, when breathing in, the ribcage expands, compressing the garment. When breathing out, the ribcage collapses and compression on garment is reduced. The rhythmic compression on the garment creates pressure fluctuation that is reflected in the fluid chamber of the air pulse generator. Following ideal gas Boyle's law, a change in the fluid volume in the garment due to ribcage compression against the garment raises the pressure in the fluid chamber.

HFCWO systems can be grouped into pneumatics and portable vibration motor types. Generally, HFCWO systems include an open loop system with the user determining the therapy intensity/frequency and duration.

### SUMMARY

The present disclosure includes one or more of the features recited in the appended claims and/or the following features which, alone or in any combination, may comprise patentable subject matter.

According to a first aspect of the disclosed embodiments, a method of improving comfort with a high-frequency chest wall oscillation (HFCWO) system includes subjecting volunteers to a first therapy and a second therapy with the HFCWO system. The method also includes calculating a plurality of airflow metrics of the first therapy and the second therapy based on airflow data from the HFCWO system. The method also includes calculating an efficacy score of each of the plurality of airflow metrics based on a comparison of each airflow metric of the second therapy to each respective airflow metric of the first therapy. The method also includes calculating a total score of the second therapy based on a combination of the efficacy scores of each of the plurality of airflow metrics and a comfort level of the second therapy.

In some embodiments of the first aspect, the plurality of airflow metrics can include an average mean flow rate of the system. The average mean flow rate of the second therapy can be scored based on whether the average mean flow rate of the second therapy is at least 2% higher than the average mean flow rate of the first therapy. The plurality of airflow metrics can include an average peak to peak value of the system. The average peak to peak value of the second therapy can be scored based on whether the average peak to peak value of the second therapy is at least 2% higher than the average peak to peak value of the first therapy. The plurality of airflow metrics can include a peak expiration to peak inspiration ratio of the system. The average peak expiration to peak inspiration ratio of the second therapy can be scored based on whether the peak expiration to peak inspiration ratio of the second therapy is at least 2% higher than the peak expiration to peak inspiration ratio of the first therapy.

Optionally, in the first aspect, the comfort level of the second therapy can be based on an average range of the airflow of the system. The average range of the airflow of the system can be scored based on whether the average range of the airflow of the second therapy is at least 2% less than the average range of the airflow of the first therapy. The comfort level of the second therapy can be scored based on a preference of the volunteer. The second therapy can include a different intensity of pulse width modulation than the first therapy.

It may be desired, in the first aspect, that each of the first therapy and the second therapy are configured to synchronize compression of a garment of the HFCWO system with a respiratory exhale. Each of the first therapy and the second therapy can be configured to synchronize relaxation of the garment with a respiratory inhale. Each of the first therapy and the second therapy can be configured to pause if a cough is detected. A cough can be detected when a rate of change in a pressure of the airflow is at least 40% greater than a predetermined rate of change in pressure. A cough can be detected when a rate of change in an acceleration of the airflow is at least 40% greater than a predetermined rate of change in acceleration.

According to a second aspect of the disclosed embodiments, a method of improving comfort with a high-frequency chest wall oscillation (HFCWO) system includes subjecting volunteers to a first therapy and a plurality of second therapies with the HFCWO system. The method also includes collecting airflow data from the HFCWO system during the first therapy and the plurality of second therapies. The method also includes comparing the airflow data from each of the plurality of second therapies to the airflow data of the first therapy. The method also includes calculating an efficacy score of the plurality of second therapies based on the comparison of the airflow data from each of the plurality of second therapies to the airflow data of the first therapy. The method also includes calculating a comfort score of each of the plurality of second therapies based on a comfort level of each of the plurality of second therapies. The method also includes calculating a total score of each of the plurality of second therapies based on the efficacy score and the comfort score.

In some embodiments of the second aspect, the airflow data can include an average mean flow rate of the system. The average mean flow rate of each of the plurality of second therapies can be scored based on whether the average mean flow rate of the respective second therapy is at least 2% higher than the average mean flow rate of the first therapy. The airflow data can include an average peak to peak value of the system. The average peak to peak value of each of the plurality of second therapies can be scored based on whether the average peak to peak value of the respective second therapy is at least 2% higher than the average peak to peak value of the first therapy. The airflow data can include a peak expiration to peak inspiration ratio of the system. The average peak expiration to peak inspiration ratio of each of the plurality of second therapies can be scored based on whether the peak expiration to peak inspiration ratio of the respective second therapy is at least 2% higher than the peak expiration to peak inspiration ratio of the first therapy.

Optionally, in the second aspect, the comfort level of each of the plurality of second therapies can be based on an average range of the airflow of the system for the respective second therapy. The average range of the airflow of the system for the respective second therapy can be scored based on whether the average range of the airflow of the respective second therapy is at least 2% less than the average range of the airflow of the first therapy. The comfort level of each of the plurality of second therapies can be scored based on a preference of the volunteer for the respective second therapy. The plurality of second therapies can include a different intensity of pulse width modulation than the first therapy.

It may be contemplated, in the second aspect, that the first therapy and each of the plurality of second therapies can be configured to synchronize compression of a garment of the HFCWO system with a respiratory exhale. The first therapy and each of the plurality of second therapies can be configured to synchronize relaxation of the garment with a respiratory inhale. The first therapy and each of the plurality of second therapies can be configured to pause if a cough is detected. A cough can be detected when a rate of change in a pressure of the airflow is at least 40% greater than a predetermined rate of change in pressure. A cough can be detected when a rate of change in an acceleration of the airflow is at least 40% greater than a predetermined rate of change in acceleration.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a high frequency chest wall oscillation therapy (HFCWO) system having an air pulse generator fluidly coupled to a garment configured to be worn by a patient, wherein the air pulse generator delivers pressurized fluid from a fluid chamber to the garment to provide a force of high frequency pressure oscillation to a patient's chest wall;

FIG. 2 is an inside view of the garment configured to be worn by the patient;

FIG. 3 is an outside view of the garment configured to be worn by the patient;

FIG. 4 is a back view of a fluid bladder positioned in the garment;

FIG. 5 is a schematic view of a control system for operating the HFCWO system shown in FIG. 1.

FIG. 6 is a flowchart of a method of operating the system shown in FIG. 1 to control the motor;

FIG. 7 is a graph of respiratory data overlaid on a graph of motor operation;

FIG. 8 is a graph of airflow from the patient compared a pressure of the garment when the motor is not controlled using the method shown in the flowchart of FIG. 17;

FIG. 9 is a graph of airflow from the patient compared a pressure of the garment when the motor is controlled using the method shown in the flowchart of FIG. 17;

FIG. 10 is a flowchart of another method of operating the system shown in FIG. 1 to provide a pause in airflow when a cough is detected;

FIG. 11 is a chart illustrating various pulse width modulation percentages of the blower during a baseline therapy and a plurality of test therapies;

FIG. 12 is a flowchart of a method of improving comfort in the system shown in FIG. 1 by subjecting volunteers to the baseline therapy and the plurality of test therapies shown in FIG. 11; and

FIG. 13 is a chart of each of the plurality of test therapies scored for patient comfort.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

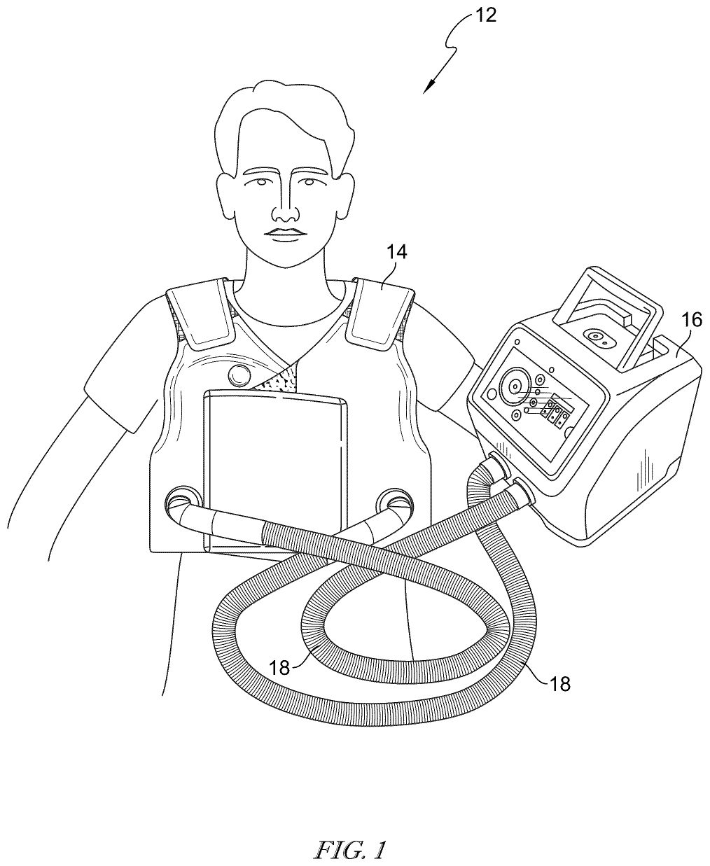

Referring now to FIG. 1, a high frequency chest wall oscillation therapy system (HFCWO) system 12 is shown including a chest engagement device 14 embodied as a wearable therapy garment vest, an air pulse generator (e.g., pump) 16 in communication with the garment 14 via one or more fluid hoses 18 to provide pressurized fluid oscillation communicated by the garment 14 to the patient's torso region to provide impact force to the patient's chest wall. Non-limiting examples of a suitable force generator and/or force generation mechanism, for example, as force generator 16 and the GUI screens for control and/or operations such generators and/or mechanisms, is provided as within U.S. patent application Ser. No. 17/093,764, entitled Adaptive High Frequency Chest Wall Oscillation System, filed on Nov. 10, 2020, the contents of which are incorporated by reference in their entirety, including but not limited to those portions concerning high frequency chest wall oscillation systems, devices, and methods. The garment 14 illustratively includes one or more pressurizable chambers that are arranged in communication with the pump 16 to receive successive pressurization and depressurization to inflate and partly deflate imposing an oscillating impact force on the patient. The application of successive impact force to impose high frequency oscillation of the chest wall as a therapy regime assists in dislodging mucus from the upper respiratory tract.

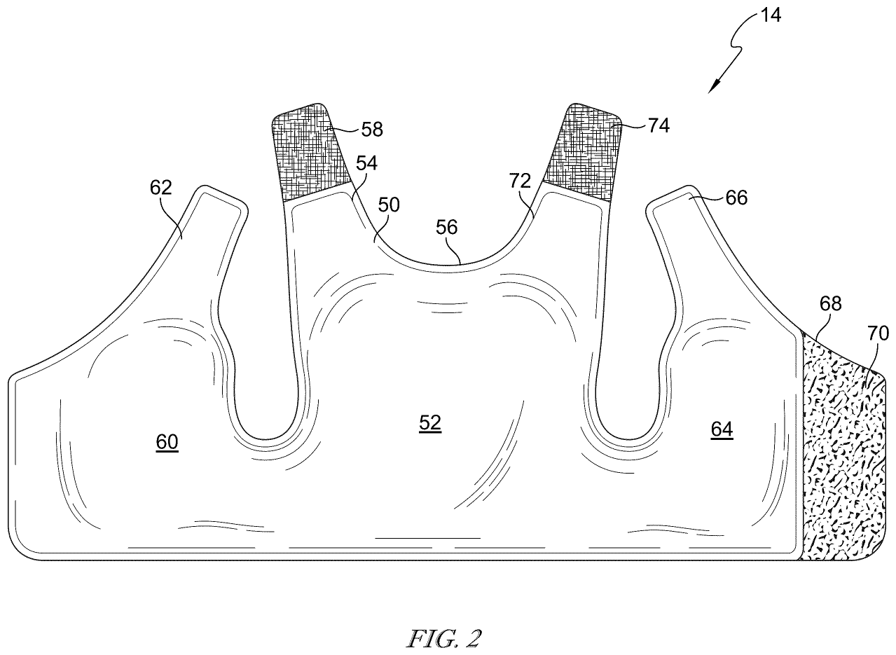

FIG. 2 illustrates an inside 50 of the garment 14, wherein the inside 50 is configured to position against a patient's body. The garment 14 includes a center panel 52 having a right shoulder flange 54 and a left shoulder flange 72 extending from a top 56 of the center panel 52. The right shoulder flanges 54 includes a fastener 58, e.g. a hook and loop fastener. The left shoulder flanges 72 includes a fastener 74, e.g. a hook and loop fastener. It will be appreciated that any suitable fastener is positioned on the right shoulder flange 54 and the left shoulder flange 72, in some embodiments. The center panel 52 is configured to position against the patient's back. The shoulder flanges 54 and 72 are configured to position over the patient's shoulders.

A right side panel 60 extends from the center panel 52 and is configured to be positioned against the right side of the patient's chest. A right shoulder flange 62 extends upward from the right side panel 60. A left side panel 64 extends from the center panel 52 and is configured to be positioned against the left side of the patient's chest. A left shoulder flange 66 extends upward from the left side panel 64. The left side panel 64 includes a flange 68 extending therefrom and having a fastener 70, e.g. a hook and loop fastener. It will be appreciated that any suitable fastener is positioned on the flange 68, in some embodiments.

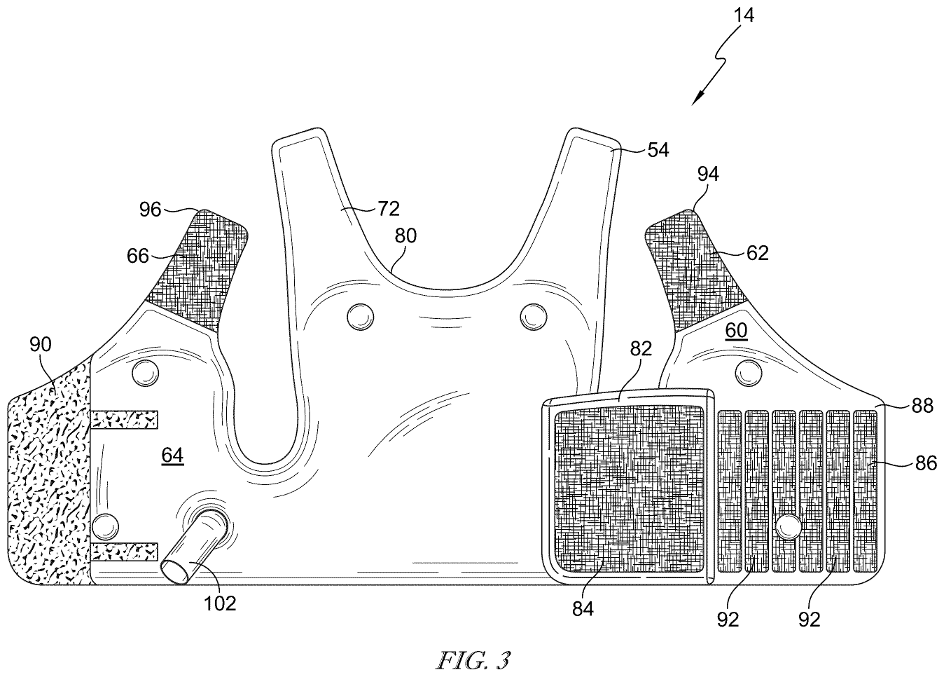

FIG. 3 illustrates an outside 80 of the garment 14. The right side panel 60 includes a flap 82 extending therefrom and having a fastener 84, e.g. a hook and loop fastener. It will be appreciated that any suitable fastener is positioned on the flap 82, in some embodiments. Another fastener 86, e.g. a hook and loop fastener, is positioned on an end 88 of the right side panel 60. The flap 82 is configured to move between a closed position, wherein the flap 82 lies over the end 88, and an open position, wherein the flap 82 is cantilevered from the right side panel 60. The left side panel 64 includes a fastener 90, e.g. a hook and loop fastener. It will be appreciated that any suitable fastener is positioned on the left side panel 64, in some embodiments.

When the garment 14 is secured to the patient, the center panel 52 is positioned on the patient's back and the right side panel 60 is wrapped around the patient's chest with the flap 82 in the open position. The left side panel 64 is then wrapped around the patient's chest so that the fastener 70 secures to the fastener 86 on the end 88 of the right side panel 60. The fastener 86 includes a plurality of fastener sections 92 that enable the patient to identify a location of the left side panel 64 on the right side panel 60, i.e. positioned at the third fastener section 92. Accordingly, during subsequent uses of the garment 14, the garment 14 is comfortably positioned on the patient by adhering the left side panel 64 at the same location on the right side panel 60 during each use. The flap 82 is then moved to the closed position so that the fastener 84 on the flap 82 is secured to the fastener 90 of the left side panel 64.

The right shoulder flange 62 includes a fastener 94, e.g. a hook and loop fastener, and the left shoulder flange 66 includes a fastener 96, e.g. a hook and loop fastener. It will be appreciated that any suitable fastener is positioned on the right shoulder flange 62 and the left shoulder flange 66, in some embodiments. The right shoulder flange 54 is wrapped around the patient's right shoulder so that the fastener 58 secures to the fastener 94 of the right shoulder flange 62. The left shoulder flange 72 is wrapped around the patient's left shoulder so that the fastener 74 secures to the fastener 96 of the left shoulder flange 66.

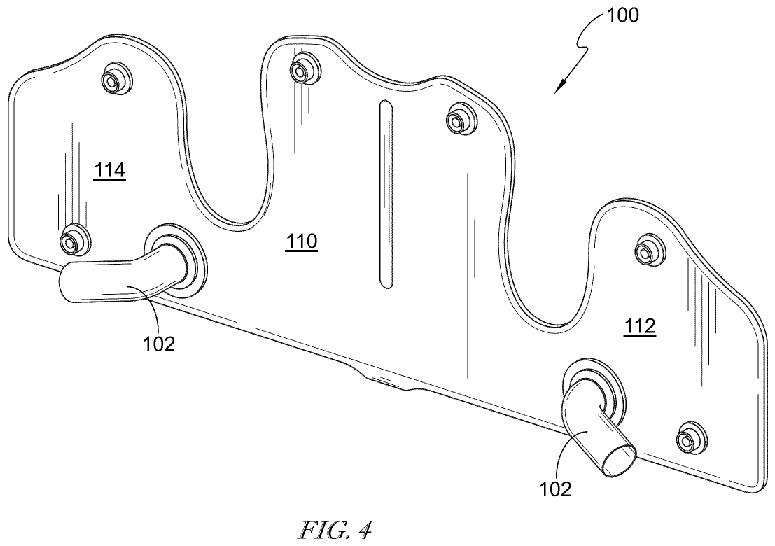

The outside 80 and the inside 50 of the garment 14 form a pocket for at least one fluid bladder 100, as shown in FIG. 4. A hose port 102 for each hose 18 extends from the fluid bladder 100 through the outside 80 of the garment 14, as shown in FIG. 3. Referring the FIG. 4, the fluid bladder 100 includes a center panel 110. A right side panel 112 and left side panel 114 each extend from the center panel 110. The center panel 110 is configured to position in the center panel 52 of the garment 14, so that the center panel 110 is positioned adjacent the patient's back. The right side panel 112 is configured to position in the right side panel 60 of the garment 14, so that the right side panel 112 is positioned adjacent the right side of the patient's chest. The left side panel 114 is configured to position in the left side panel 64 of the garment 14, so that the left side panel 112 is positioned adjacent the left side of the patient's chest.

A hose port 102 is fluidly coupled to each of the right side panel 112 and the left side panel 114 to couple to a hose 18. Pressurized fluid from the air pulse generator 16 is directed into the fluid bladder 100 from the hoses 18 and through the respective hose port 102 to oscillate pressure in the fluid bladder 100. It will be appreciated that, in some embodiments, the fluid bladders 100 include a plurality of fluid bladders that each receive pressurized fluid from the air pulse generator 16.

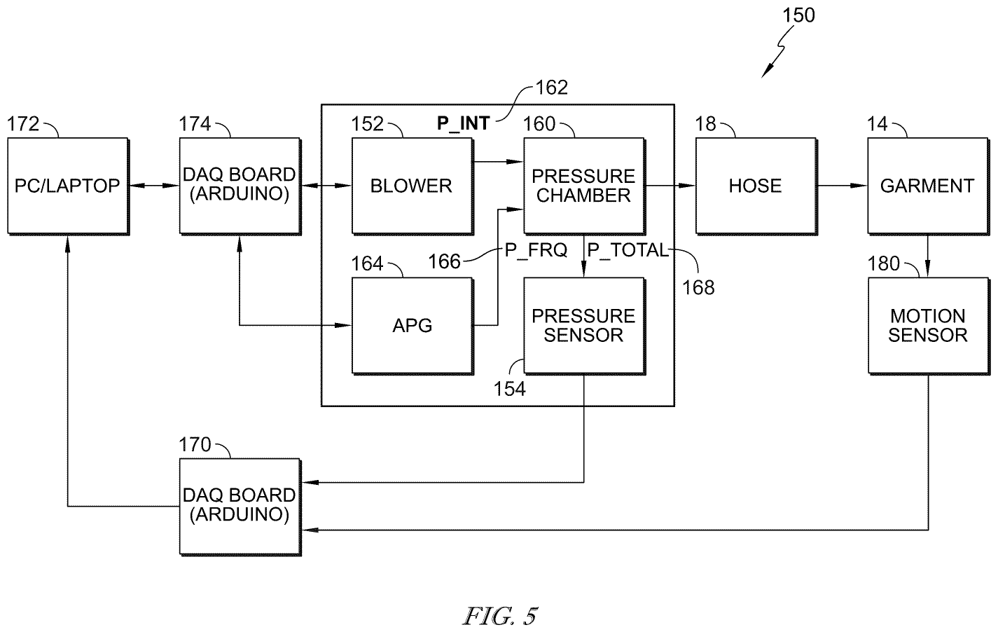

FIG. 5 is a schematic view of a control circuitry 150 for operating the HFCWO system 12 shown in FIG. 1. A blower 152 is configured to discharge air into a pressurizable chamber 160 at a selected intensity 162. An air pulse generator 164 pulsates the air entering the pressurizable chamber 160 at a frequency 166. A total pressure 168 in the pressurizable chamber 160 is measured with a pressure sensor 154. The pressure sensor 154 sends a signal indicative of airflow data to a circuit board 170. The circuit board 170 processes the airflow data and sends signals indicative of airflow metrics to a computer 172. In some embodiments, the airflow metric include average mean flow rate of the system 12, average peak to peak value of the system 12, peak expiration to peak inspiration ratio of the system 12, and average range of the airflow in the system 12. The computer 172 is utilized to adjust the airflow based on at least one of the methods described below. The computer 172 delivers a signal to another circuit board 174, which, in turn, delivers signals to the blower 152 and the air pulse generator 164 to adjust the intensity and frequency of the airflow.

The air is discharged from the pressurizable chamber 160 through the hose 18 to the garment 14. A motion sensor 180 detects movement of the garment 14, for example, compression and relaxation. The motion sensor 180 also detects movement of the patient, in one embodiment, the motion sensor 180 transmits a signal to the circuit board 170 indicative of the movement of the patient and/or the garment 14. The circuit board 170 processes the signal as part of the process of outputting the airflow metrics to the computer 172.

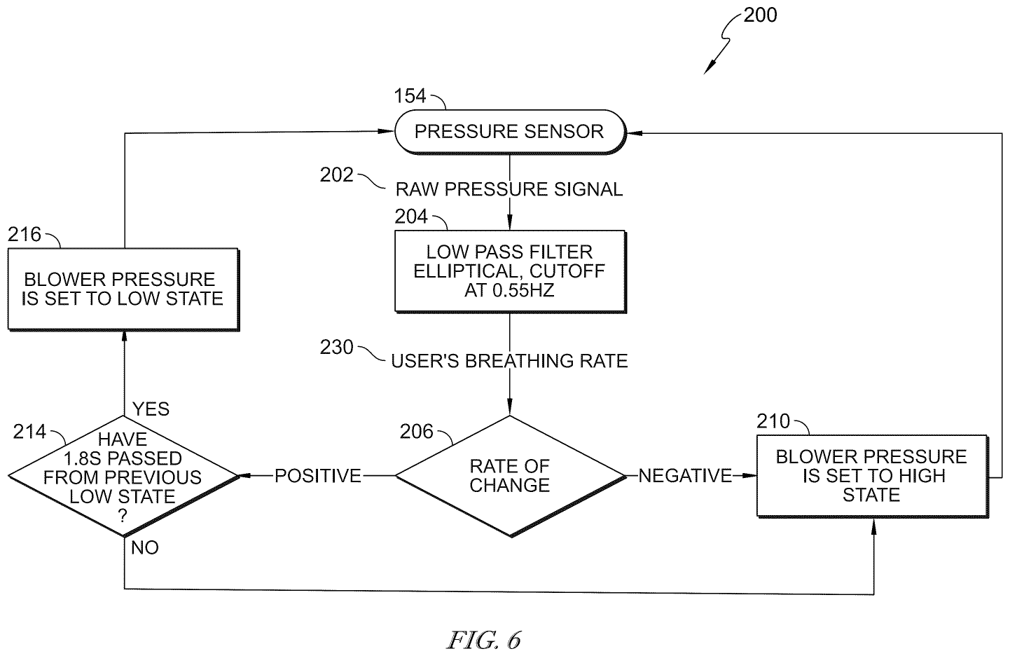

Referring to FIG. 6, a flowchart 200 illustrates a method of operating the system 12 to control the blower 152. At block 202, the pressure sensor 154 acquires a raw pressure signal. At block 204 the raw pressure signal is filtered. In some embodiments, the raw pressure signal is filtered with a low pass filter. In some embodiments, the raw pressure signal is filtered with an elliptical filter having a cutoff at 0.55 Hz. The raw pressure signal is filtered to obtain a user's (patient's) breathing rate 230. In some embodiments, the control circuitry 150 waits a predetermined period, for example 10 seconds, for filter signal stability before proceeding to the next block 206. At decision block 206, the control circuitry 150 determines a rate of change in the user's breathing rate. That is, the filtered signal is differentiated to determine a direction of airflow.

If the rate of change is negative, the control circuitry 150 sets the blower 152 to a high state, at block 210, and then continues to obtain the raw pressure signal, at block 202. If the rate of change, at block 206, is positive, the control circuitry 150, at block 214, determines whether a predetermined period of time has passed since the last low state. In some embodiments, the predetermined period of time is 1.8 seconds. If the predetermined period of time has not passed, the control circuitry 150 sets the blower 152 to a high state, at block 210, and then continues to obtain the raw pressure signal, at block 202. If the predetermined period of time has passed, the control circuitry 150 sets the blower 152 to the low state, at block 216, and then continues to obtain the raw pressure signal, at block 202.

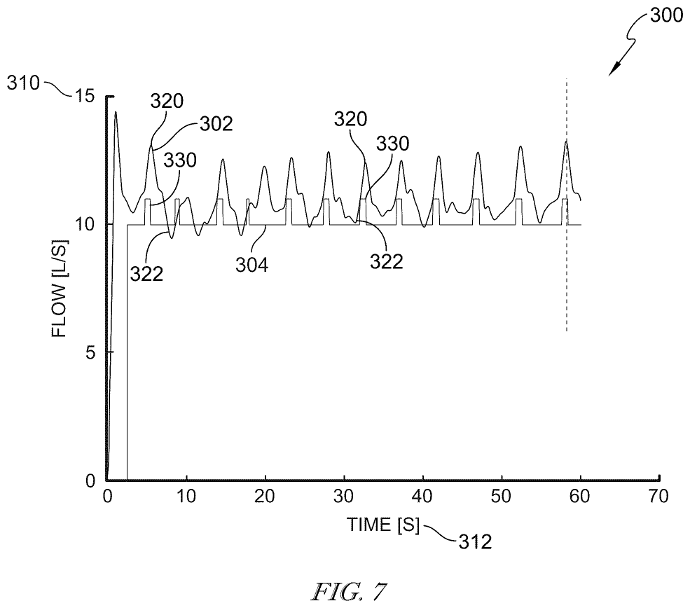

FIG. 7 illustrates a graph 300 of an airflow signal 302 from the patient overlaid on a signal 304 indicative of motor operation, when the method 200 is in use. The graph 300 illustrates airflow 310 in L/s on the y-axis over time 312 in seconds on the x-axis. The pattern of the signal 302 is divisible into inhalation segments 320 indicative of inhalation by the patient and exhalation segments 322 indicative of exhalation of the patient. The blower 152 is altered to decrease the flow of the pressurized fluid from a fluid chamber of the blower 152 to the pressurizable chamber 160 when the patient inhales. That is, the blower 152 is operated at a low state when the patient inhales. The signal 304 illustrates when the low state is triggered at spikes 330. The blower 152 is altered to increase the flow of the pressurized fluid from the fluid chamber of the blower 152 to the pressurizable chamber 160 when the patient exhales. That is, the blower 152 is operated at a high state when the patient exhales. The force of the high frequency pressure oscillation to the patient's chest wall includes a compressive force and an opposite expansive force. The compressive force is synchronized with an exhalation by the patient. The expansive force is synchronized with an inhalation by the patient.

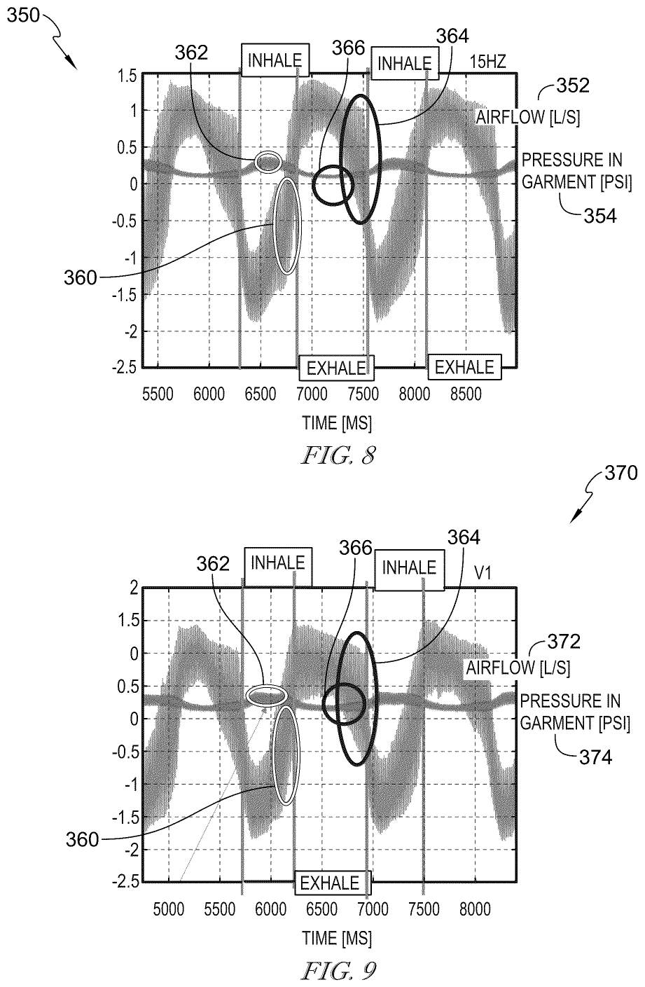

FIG. 8 is a graph 350 of an airflow signal 352 in L/s from the patient compared a pressure signal 354 in PSI of the garment when the blower 152 is not controlled using the method shown in the flowchart 200. FIG. 9 is a graph 370 of an airflow signal 372 in L/s from the patient compared a pressure signal 374 in PSI of the garment when the blower 152 is controlled using the method shown in the flowchart 200. Each graph 350 and 370 illustrates an end of inhale 360 on the respective airflow signal 352, 372 and an end of inhale 362 on the respective pressure signal 354, 374. Each graph 350 and 370 also illustrates an end of exhale 364 on the respective airflow signal 352, 372 and an end of exhale 366 on the respective pressure signal 354, 374. The method described above results in the pressure in garment being modified in real time so that a peak pressure is shaved off in the user's respiratory pattern, as shown at point 380 in the pressure signal 374.

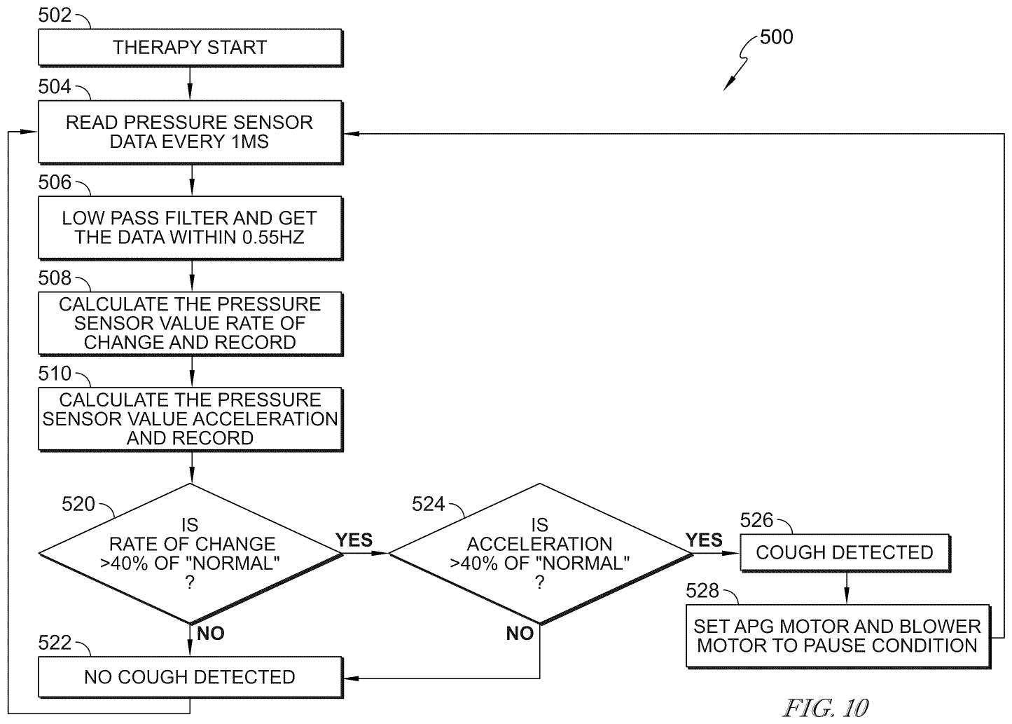

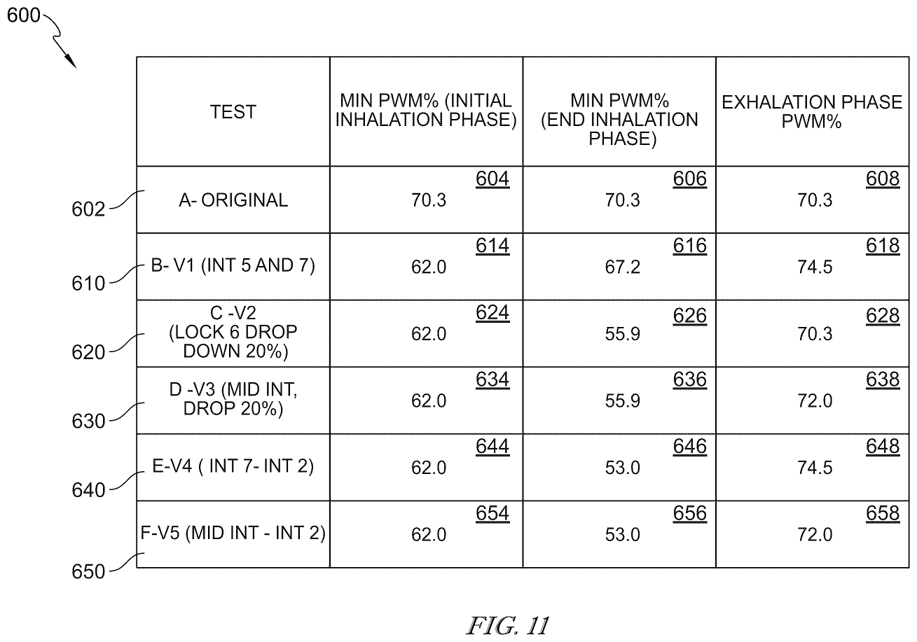

Referring now to FIG. 10, another method 500 for operating the system 12 includes starting therapy with the system 12, at block 502. At block 504, the control circuitry 150 reads a data signal from the pressure sensor 154 every 1 millisecond. The data signal includes data related to the pressure measured in the pressurizable chamber 160. In some embodiments, the control circuitry 150 reads the data signal from the pressure sensor 154 at any predetermined interval. At block 506, the data signal is filtered and data segment is collected from the data signal. In some embodiments, the data signal is filtered with a low pass filter. In some embodiments, data is collected within 0.55 Hz. At block 508, a rate of change in the pressure sensor 154 is calculated and stored, and, at block 510, an acceleration of the airflow detected by the pressure sensor 154 is calculated and stored.

At decision block 520, the control circuitry 150 determines whether the rate of change in the pressure sensor 154 is greater than a predetermined value. In some embodiments, the control circuitry 150 determines whether the rate of change in the pressure sensor 154 is 40% greater than the predetermined value. If the rate of change is not greater than the predetermined value, the control circuitry 150 determines that no cough is detected, at block 522, and the pressure sensor 154 continues to collect data, at block 504. If the rate of change is greater than the predetermined value, the control circuitry 150 determines whether the acceleration is greater than a predetermined value, as decision block 524. In some embodiments, the control circuitry 150 determines whether the acceleration is 40% greater than the predetermined value. If the acceleration is not greater than the predetermined value, the control circuitry 150 determines than no cough is detected, at block 522, and the pressure sensor 154 continues to collect data, at block 504. If the acceleration is greater than the predetermined value, the control circuitry 150 determines that a cough has been detected, at block 526. Accordingly, at block 528, the blower 150 is set to a pause condition, and the pressure sensor 154 continues to collect data, at block 504.

FIG. 11 illustrates a chart 600 of various test conditions for the system 12. The various test conditions utilize different intensities of blower motor strength a measured by pulse width modulation percentage (PWM %). For example, a first intensity has a PWM % of 44.7% duty cycle, a second intensity has a PWM % of 53.0% duty cycle, a third intensity has a PWM % of 58.4% duty cycle, a fourth intensity has a PWM % of 64.0% duty cycle, a fifth intensity has a PWM % of 67.2% duty cycle, a sixth intensity has a PWM % of 70.3% duty cycle, and a seventh intensity has a PWM % of 74.5% duty cycle.

A baseline treatment or therapy 602 is operated at the sixth intensity. That is, a minimum PWM % at the initial inhalation phase 604 or during ribcage initial expansion is 70.3% duty cycle, a minimum PWM % at the end inhalation phase 606 or during maximum ribcage expansion is 70.3% duty cycle, and an exhalation phase PWM % 608 during ribcage compression is 70.3% duty cycle 3. A first test treatment or therapy 610 is operated at the fifth intensity and the seventh intensity. That is, the minimum PWM % at the initial inhalation phase 614 is 62.0% duty cycle, the minimum PWM % at the end inhalation phase 616 is 67.2% duty cycle, and the exhalation phase PWM % 618 is 74.5% duty cycle. A second test treatment or therapy 620 is operated with a 20% drop from the sixth intensity. That is, the minimum PWM % at the initial inhalation phase 624 is 62.0% duty cycle, the minimum PWM % at the end inhalation phase 626 is 55.9% duty cycle, and the exhalation phase PWM % 628 is 70.3% duty cycle. A third test treatment or therapy 630 is operated with a 20% drop from an intermediate intensity between 6 and 7. That is, the minimum PWM % at the initial inhalation phase 634 is 62.0% duty cycle, the minimum PWM % at the end inhalation phase 636 is 55.9% duty cycle, and the exhalation phase PWM % 638 is 72.0% duty cycle. A fourth test treatment or therapy 640 is operated with the seventh and second intensities. That is, the minimum PWM % at the initial inhalation phase 644 is 62.0% duty cycle, the minimum PWM % at the end inhalation phase 646 is 53.0% duty cycle, and the exhalation phase PWM % 648 is 74.5% duty cycle. A fifth test treatment or therapy 650 is operated with intermediate intensity between 6 and 7 plus the minimum PWM % at the initial inhalation phase 654 at 62.0% duty cycle, the minimum PWM % at the end inhalation phase 656 at 53.0% duty cycle, and the exhalation phase PWM % 658 at 72.0% duty cycle.

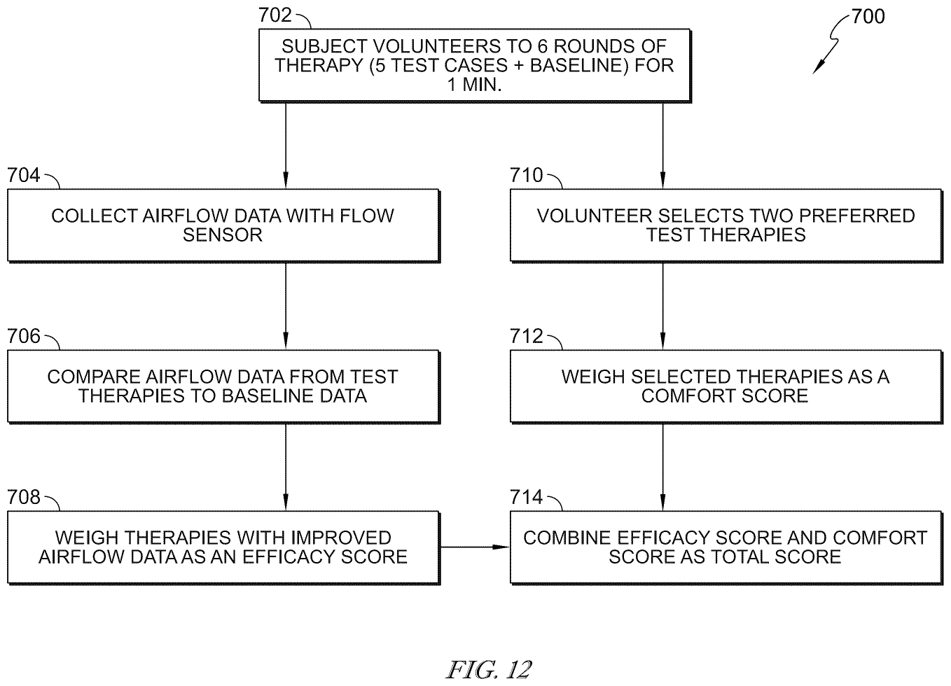

Referring now to FIG. 12, a method 700 of improving comfort with the system 12 includes subjecting volunteers to the baseline therapy 602 and the test therapies 610, 620, 630, 640, and 650 with the HFCWO system 12, at block 702. In some embodiments, each volunteer is subject to each of the baseline therapy 602 and the test therapies 610, 620, 630, 640, and 650 for one minute. In other embodiments, each volunteer is subjected to each of the baseline therapy 602 and the test therapies 610, 620, 630, 640, and 650 for another suitable predetermined period of time. At block 704, various airflow metrics of each of the baseline therapy 602 and the test therapies 610, 620, 630, 640, and 650 are calculated by the control circuitry 150 based on data from the pressure sensor 154. In some embodiments, the airflow metrics include at least one of an average mean flow rate of the system 12, an average peak to peak value of the system 12, and a peak expiration to peak inspiration ratio of the system 12. At block 706, each of the airflow metrics from each of the test therapies 610, 620, 630, 640, and 650 are compared to each of the airflow metrics of the baseline therapy 602.

At block 708, each airflow metric of each the test therapies 610, 620, 630, 640, and 650 is scored to determine an efficacy score of each airflow metric of each the test therapies 610, 620, 630, 640, and 650 compared to the respective airflow metric of the baseline therapy 602. In some embodiments, the average mean flow rate of each test therapy 610, 620, 630, 640, and 650 is scored based on whether the average mean flow rate of the test therapy 610, 620, 630, 640, and 650 is at least 2% higher than the average mean flow rate of the baseline therapy 602. In some embodiments, the average peak to peak value of each test therapy 610, 620, 630, 640, and 650 is scored based on whether the average peak to peak value of the test therapy 610, 620, 630, 640, and 650 is at least 2% higher than the average peak to peak value of the baseline therapy 602. In some embodiments, the average peak expiration to peak inspiration ratio of each test therapy 610, 620, 630, 640, and 650 is scored based on whether the peak expiration to peak inspiration ratio of the test therapy 610, 620, 630, 640, and 650 is at least 2% higher than the peak expiration to peak inspiration ratio of the baseline therapy 602. In some embodiments, the average peak expiration to peak inspiration ratio of each test therapy 610, 620, 630, 640, and 650 is scored based on whether an absolute value of the peak expiration to peak inspiration ratio of the test therapy 610, 620, 630, 640, and 650 is at least 2% higher than the peak expiration to peak inspiration ratio of the baseline therapy 602.

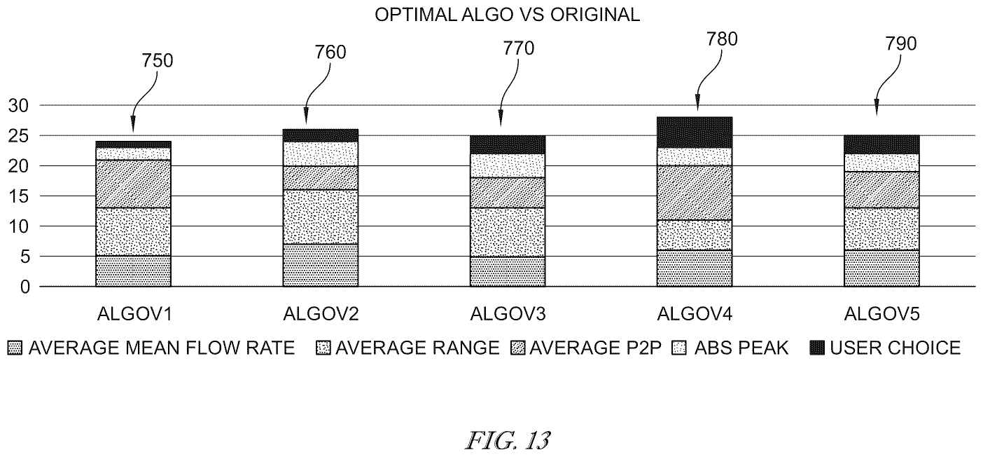

At block 710, each volunteer selects two preferred therapies from the baseline therapy 602 and the test therapies 610, 620, 630, 640, and 650. At block 712, the selected therapies are scored as a comfort score. In some embodiments, an average range of the airflow of the system 12 is also scored as a comfort score. At block 714, each of the efficacy scores and the comfort scores are total to determine a total score for each treatment, as illustrated in FIG. 13. During use, the total score for each treatment is used to select an appropriate treatment for a future patient. In some embodiments, the treatments with the highest total score are used as preferred treatments for patient comfort when using the system 12.

FIG. 13 illustrates the total score for each of the test therapies 610, 620, 630, 640, and 650 defined in FIG. 11 and tested with 10 volunteers using the method described in FIG. 12. For the first test therapy 610, the average mean flow rate was scored for 5 patients. That is, for 5 patients the average mean flow rate for the first test therapy 610 was a predetermined percentage higher than the average mean flow rate of the baseline therapy 602. For the first test therapy 610, the average range of the airflow was scored for 8 patients. That is, for 8 patients the average range of the airflow for the first test therapy 610 was a predetermined percentage higher than the average range of the airflow of the baseline therapy 602. For the first test therapy 610, the average peak to peak value was scored for 8 patients. That is, for 8 patients the average peak to peak value for the first test therapy 610 was a predetermined percentage higher than the average peak to peak value of the baseline therapy 602. For the first test therapy 610, the peak expiration to peak inspiration ratio was scored for 2 patients. That is, for 2 patients the peak expiration to peak inspiration ratio for the first test therapy 610 was a predetermined percentage higher than the peak expiration to peak inspiration ratio of the baseline therapy 602. For the first test therapy 610, the treatment was preferred and scored for 1 patient for a total score 750 of 24. That is, 1 patient preferred using the setting of the first test therapy 610. It will be appreciated that in some embodiments, an airflow metric for a test treatment is scored when the airflow metric for the test treatment is a predetermined percentage lower than the respective airflow metric of the baseline therapy 602.

The remaining test therapies 620, 630, 640, and 650 are scored as set forth above with respect to the first test therapy 610. For the second test therapy 620, the average mean flow rate was scored for 7 patients, the average range of the airflow was scored for 9 patients, the average peak to peak value was scored for 4 patients, the peak expiration to peak inspiration ratio was scored for 4 patients, and the treatment was preferred and scored for 2 patients for a total score 760 of 26. For the third test therapy 630, the average mean flow rate was scored for 5 patients, the average range of the airflow was scored for 8 patients, the average peak to peak value was scored for 5 patients, the peak expiration to peak inspiration ratio was scored for 4 patients, and the treatment was preferred and scored for 3 patients for a total score 770 of 25. For the fourth test therapy 640, the average mean flow rate was scored for 6 patients, the average range of the airflow was scored for 5 patients, the average peak to peak value was scored for 9 patients, the peak expiration to peak inspiration ratio was scored for 3 patients, and the treatment was preferred and scored for 5 patients for a total score 780 of 28. For the fifth test therapy 650, the average mean flow rate was scored for 6 patients, the average range of the airflow was scored for 7 patients, the average peak to peak value was scored for 6 patients, the peak expiration to peak inspiration ratio was scored for 3 patients, and the treatment was preferred and scored for 3 patients for a total score 790 of 25.

Accordingly, the fourth test treatment 640 was the most preferred treatment from the test described above. As such, in some embodiments, the fourth test treatment 640 is utilized as a preferred treatment for future patients. In some embodiments, the test data varies based on physical attributes of the patient, for example, height, weight, sex, age, etc. As such, the method 700 is usable to test various treatments for any patient demographic and weigh the treatments based on comfort and efficacy. In some embodiments, the test data is utilized to adjust a baseline pressure of a patient's therapy. In some embodiments, the baseline pressure is adjusted based on a preferred comfort level of the patient.

The disclosed embodiments provide a methodic design technique for HFCWO therapy that takes into consideration therapy efficacy and patient's comfort. In some embodiments, “comfort” is defined as combining a patient's subjective preference (user's choice) and an objective measurement (tidal volume airflow). In some embodiments, “efficacy” is defined as common methods used in literature studies for assessment, for example average mean flow rate, average peak2peak pulse flow, and absolute peak expiration/inspiration ratio. In some embodiments, the methodology process is initialized to generate input for testing. Five test cases were studied with variations of intensity in PWM % to be input into the system 12 against a frequency 15 and intensity 6 as a baseline comparison. Data acquisition included subjecting 10 volunteer subjects to 6 rounds of therapy (5 test cases+baseline) for 1 min. The airflow data was collected with a pneumotach flow sensor, in one embodiment. Each volunteers preferred choice of the 5 test cases was logged. In one embodiment, the Airflow data was processed using Matlab and 4 key data metrics were extracted from the data: the average mean flow rate, the average peak2peak pulse flow, the range of airflow, and the absolute peak expiration/inspiration ratio. In some embodiments, the data metrics are combined with a user's preference. In some embodiments, the 4 data metrics for 5 test cases were compared against the baseline case. Similar results or improvement in results were given a score magnitude of 1, in some embodiments, and were combined with user's preferred choice. The output results were tabulated to display a recommended input as an optimal design choice. The techniques illustrated were applicable to all possible variations (freq/int) of HFCWO therapies.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A method of improving comfort with a high-frequency chest wall oscillation (HFCWO) system, the method comprising:
subjecting volunteers to a first therapy and a second therapy with the HFCWO system;
calculating a plurality of airflow metrics of the first therapy and the second therapy based on airflow data from the HFCWO system;
calculating an efficacy score of each of the plurality of airflow metrics based on a comparison of each airflow metric of the second therapy to each respective airflow metric of the first therapy; and
calculating a total score of the second therapy based on a combination of the efficacy scores of each of the plurality of airflow metrics and a comfort level of the second therapy.

2. The method of claim 1, wherein the plurality of airflow metrics includes:
an average mean flow rate of the system, wherein the average mean flow rate of the second therapy is scored based on whether the average mean flow rate of the second therapy is at least 2% higher than the average mean flow rate of the first therapy, and
an average peak to peak value of the system, wherein the average peak to peak value of the second therapy is scored based on whether the average peak to peak value of the second therapy is at least 2% higher than the average peak to peak value of the first therapy.

3. The method of claim 1, wherein the plurality of airflow metrics includes a peak expiration to peak inspiration ratio of the system, wherein the average peak expiration to peak inspiration ratio of the second therapy is scored based on whether the peak expiration to peak inspiration ratio of the second therapy is at least 2% higher than the peak expiration to peak inspiration ratio of the first therapy.

4. The method of claim 1, wherein the comfort level of the second therapy is based on an average range of the airflow of the system, wherein the average range of the airflow of the system is scored based on whether the average range of the airflow of the second therapy is at least 2% less than the average range of the airflow of the first therapy.

5. The method of claim 1, wherein the comfort level of the second therapy is scored based on a preference of the volunteer.

6. The method of claim 1, wherein the second therapy includes a different intensity of pulse width modulation than the first therapy.

7. The method of claim 1, wherein each of the first therapy and the second therapy are configured to synchronize compression of a garment of the HFCWO system with a respiratory exhale, wherein each of the first therapy and the second therapy are configured to synchronize relaxation of the garment with a respiratory inhale.

8. The method of claim 1, wherein each of the first therapy and the second therapy are configured to pause if a cough is detected, wherein a cough is detected when at least one of a rate of change in a pressure of the airflow is at least 40% greater than a predetermined rate of change in pressure and a rate of change in an acceleration of the airflow is at least 40% greater than a predetermined rate of change in acceleration.

9. A method of improving comfort with a high-frequency chest wall oscillation (HFCWO) system, the method comprising:
subjecting volunteers to a first therapy and a plurality of second therapies with the HFCWO system;
collecting airflow data from the HFCWO system during the first therapy and the plurality of second therapies;
comparing the airflow data from each of the plurality of second therapies to the airflow data of the first therapy;
calculating an efficacy score of the plurality of second therapies based on the comparison of the airflow data from each of the plurality of second therapies to the airflow data of the first therapy;
calculating a comfort score of each of the plurality of second therapies based on a comfort level of each of the plurality of second therapies; and
calculating a total score of each of the plurality of second therapies based on the efficacy score and the comfort score.

10. The method of claim 9, wherein the airflow data includes an average mean flow rate of the system.

11. The method of claim 10, wherein the average mean flow rate of each of the plurality of second therapies is scored based on whether the average mean flow rate of the respective second therapy is at least 2% higher than the average mean flow rate of the first therapy.

12. The method of claim 9, wherein the airflow data includes an average peak to peak value of the system.

13. The method of claim 12, wherein the average peak to peak value of each of the plurality of second therapies is scored based on whether the average peak to peak value of the respective second therapy is at least 2% higher than the average peak to peak value of the first therapy.

14. The method of claim 9, wherein the airflow data includes a peak expiration to peak inspiration ratio of the system.

15. The method of claim 14, wherein the average peak expiration to peak inspiration ratio of each of the plurality of second therapies is scored based on whether the peak expiration to peak inspiration ratio of the respective second therapy is at least 2% higher than the peak expiration to peak inspiration ratio of the first therapy.

16. The method of claim 9, wherein the comfort level of each of the plurality of second therapies is based on an average range of the airflow of the system for the respective second therapy.

17. The method of claim 16, wherein the average range of the airflow of the system for the respective second therapy is scored based on whether the average range of the airflow of the respective second therapy is at least 2% less than the average range of the airflow of the first therapy.

18. The method of claim 9, wherein the comfort level of each of the plurality of second therapies is scored based on a preference of the volunteer for the respective second therapy.

19. The method of claim 9, wherein each of the plurality of second therapies includes a different intensity of pulse width modulation than the first therapy.

20. The method of claim 9, wherein the first therapy and each of the plurality of second therapies are configured to synchronize compression of a garment of the HFCWO system with a respiratory exhale.

21. The method of claim 20, wherein the first therapy and each of the plurality of second therapies are configured to synchronize relaxation of the garment with a respiratory inhale.

22. The method of claim 9, wherein the first therapy and each of the plurality of second therapies are configured to pause if a cough is detected, wherein a cough is detected when at least one of a rate of change in a pressure of the airflow is at least 40% greater than a predetermined rate of change in pressure and a rate of change in an acceleration of the airflow is at least 40% greater than a predetermined rate of change in acceleration.
